(19) United States
(12) Patent Application Publication
(10) Pub. No.: US 2016/0050946 A1
(43) Pub. Date: Feb. 25, 2016

(54) FOOD PRODUCT PROCESSING AND PACKAGING SYSTEM AND METHOD

(71) Applicant: Treasure Brands, San Francisco, CA (US)

(72) Inventor: Charles Timothy CHILDS, San Francisco, CA (US)

(21) Appl. No.: 14/854,984

(22) PCT Filed: Mar. 17, 2014
(86) PCT No.: PCT/US14/30390

§ 371 Date: Sep. 15, 2015

Related U.S. Application Data
(60) Provisional application No. 61/799,855, filed on Mar. 15, 2013.

(51) Int. Cl. A23B 4/015

(52) U.S. Cl. CPC A23B 4/015

(57) ABSTRACT

Food processing and packaging systems and processes by which the food being processed and packaged is never exposed to oxidizing air throughout entire processing and packaging cycle. One or more processing chambers are provided by which juice extraction, cold sterilization/pasteurization, waste purging and packaging all occur in an oxygen-free environment maintained either by maintaining a vacuum or by positive pressure purging. The processing line can be configured to operate automatically or with robotic assistance, or manually through an air barrier, or can be operated by human labor provided with appropriate breathing apparatus.

### RELATED APPLICATIONS

This application claims the benefit of the following U.S. patent applications. This application is the National Phase of PCT Application Number PCT/US2014/030390 which in turn is a conversion of Ser. No. 61/799,855, filed Mar. 15, 2013. Both are incorporated herein by reference as though set forth in full.

### FIELD OF THE INVENTION

The present invention relates generally to food processing and packaging, and more particularly relates to processes and systems for packaging foods in an inert environment.

### BACKGROUND OF THE INVENTION

Processing of many foods, including meats, fruits and vegetables, typically involves exposing that food to air, which immediately begins the oxidation of the food. This results in the deterioration of the nutrients in the foods, as well as the flavor and freshness.

While some foods are packed for shipment or storage in nitrogen-enriched environments, this packaging typically is “too little, too late” for many foods, particularly juices, cut vegetables, cut fruits, and so on. For example, in a typical juice processing line, fruit juices are processed, from cutting and pressing all the way through packaging, in an open air environment. The degradation of the quality of the juice from such handling is significant.

Thus, there has been a long-felt need for a process and system that enables processing of foods, and particularly fruits, juices, and vegetables, without such deterioration in nutrient value, flavor and freshness.

### SUMMARY OF THE INVENTION

The present invention overcomes the numerous limitations of the prior art by providing systems and processes by which the food being processed and packaged is never exposed to air throughout entire processing and packaging cycle.

More particularly, in an embodiment, the present invention comprises an enclosed processing chamber in which juice extraction, cold process sterilization (UV, High Pressure, Ultrasonic, etc), waste purging and packaging all occur in an oxygen-free environment provided by a single enclosure. The oxygen free environment can be maintained either by maintaining a vacuum or by positive pressure purging. Such a processing line can be configured to operate automatically or with robotic assistance, or can be operated by human labor provided with appropriate breathing apparatus. In general, this embodiment can be regarded as workers manipulating the process from inside the purged environment.

In an alternative embodiment, the stages of the food processing line are maintained within separate, oxygen-free enclosures, and the various stages are connected via piping and ducting so that the food being processed is always maintained in an oxygen-free environment. As with the first embodiment, each stage can be maintained oxygen-free by either vacuum or positive pressure purging. Management of the processing within each stage can be achieved with automated equipment, or by human labor operating through glove boxes or similar. In general, this embodiment can be regarded as workers manipulating the process from outside the purged environment.

These and other features of the present invention can be better appreciated from the following Detailed Description of the Invention, taken in combination with the appended Figures.

### THE FIGURES

FIG. 1 illustrates in schematic form an embodiment of the invention wherein the process is manipulated from inside the purged environment.

FIG. 2 illustrates in schematic form an embodiment of the invention wherein the process is manipulated from outside the purged environment.

FIGS. 3A-3B illustrate top and side views of a UV Pasteurizer suitable for use with opaque or semi-opaque fluid streams, such as juice that might be processed in accordance with the invention shown in FIGS. 1 and 2.

### DETAILED DESCRIPTION OF THE INVENTION

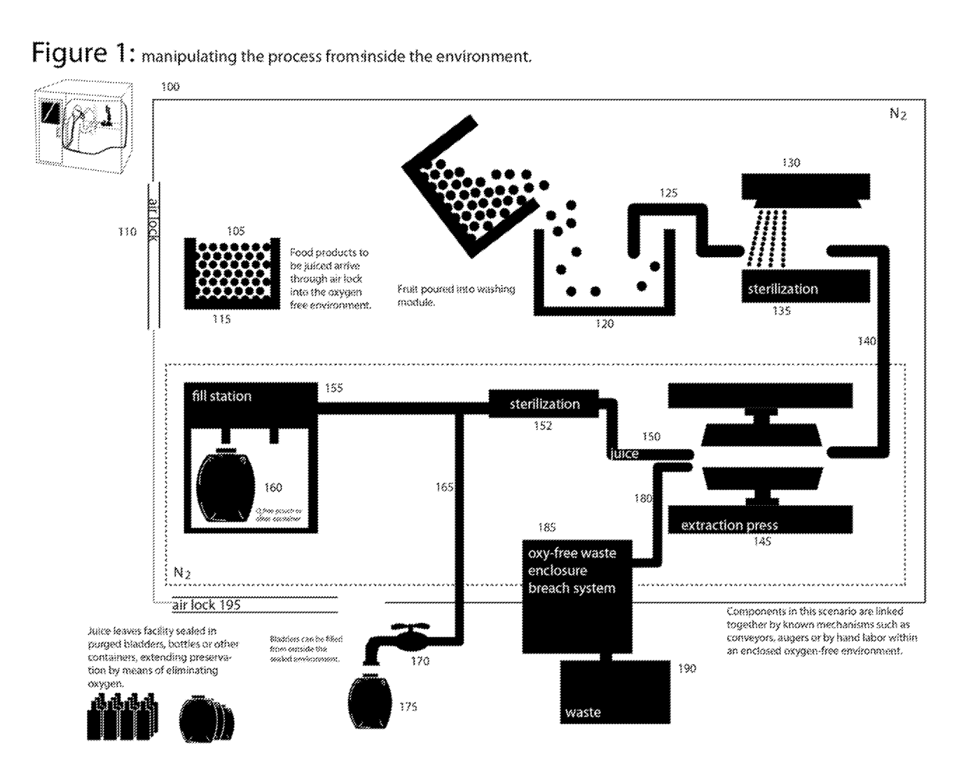

Referring first to FIG. 1, a chamber 100 is purged of oxygen either by means of a vacuum or by positive pressure purging with an inert gas, such as nitrogen. The food products to be processed, shown at 105, enter the chamber via air lock 110, and typically are maintained in a container 115 or via other means of conveyance. For simplicity of explanation, the present invention will be described in the context of processing fruit to be juiced, although those skilled in the art will understand that the example of fruit to be juiced is illustrative and not limiting, and that the processes and systems described herein can be used to process a wide variety of fruits, vegetables, juices and other foods.

Continuing with FIG. 1, the fruit 105 is poured into a washing module 120 for cleansing the outside of the fruit, for example, a citrus fruit such as oranges or limes. It will be appreciated by those skilled in the art that the cleansing step can be configured as a way of introducing the fruit into the oxygen-free environment, simply by having the entry portion of the washing module 120 on the outside of the chamber 100, and the exit portion of the washing module on the inside of the chamber 100, with the liquid in the washing module 120 maintained at a high enough level that no air is allowed to enter the chamber 100 via the module 120. The fruit is then conveyed by any convenient means, such as either an auger, a conveyor 125, or hand labor, to a UV sterilization stage 130, where the outside of the fruit is sterilized by passing the fruit along a tumbling conveyor 135 or other suitable device that causes the entire surface of the fruit to be exposed to the UV light for a sufficient period, in a manner known in the art.

The fruit is then conveyed by any convenient means 140 to an extraction press 145, where the fruit is juiced either by crushing or macerating, which results in the juice being separated from the pulp, rind, peel, and seeds, if any. The juice output from the extraction press is conveyed by any convenient means 150 to 151 an inline pasteurization unit and then to fill station 155, where oxygen-free pouches, bottles or other containers 160 are filled. Alternatively, oxygen-free containers can be filled outside the chamber 100 simply by use of a valve or spigot 170 connected in an oxygen-free manner to a container 175.

Waste from the extraction press 145 is conveyed by any convenient means 180 to an oxygen-free container 185, which in turns conveys the waste from the press to a waste bin 190 outside the chamber in any convenient manner that maintains the oxygen-free environment inside the chamber. Containers 160 containing juice—whether bladders, bottles, bags, pouches, Tetra-paks, or other suitable means—can be removed from the chamber 100 through an airlock 195. The airlock 195 can also allow human ingress into and egress from the chamber 100, and the human workers will wear breathing apparatus while inside the purged chamber.

While the chamber 100 is referred to as purged, or oxygen-free, it will be understood that “oxygen-free” is a relative term, and in most such chambers a small amount of oxygen remains. Thus, as used herein, “oxygen-free” means sufficiently oxygen-free as to substantially inhibit oxidation of the juice or other food product being processed.

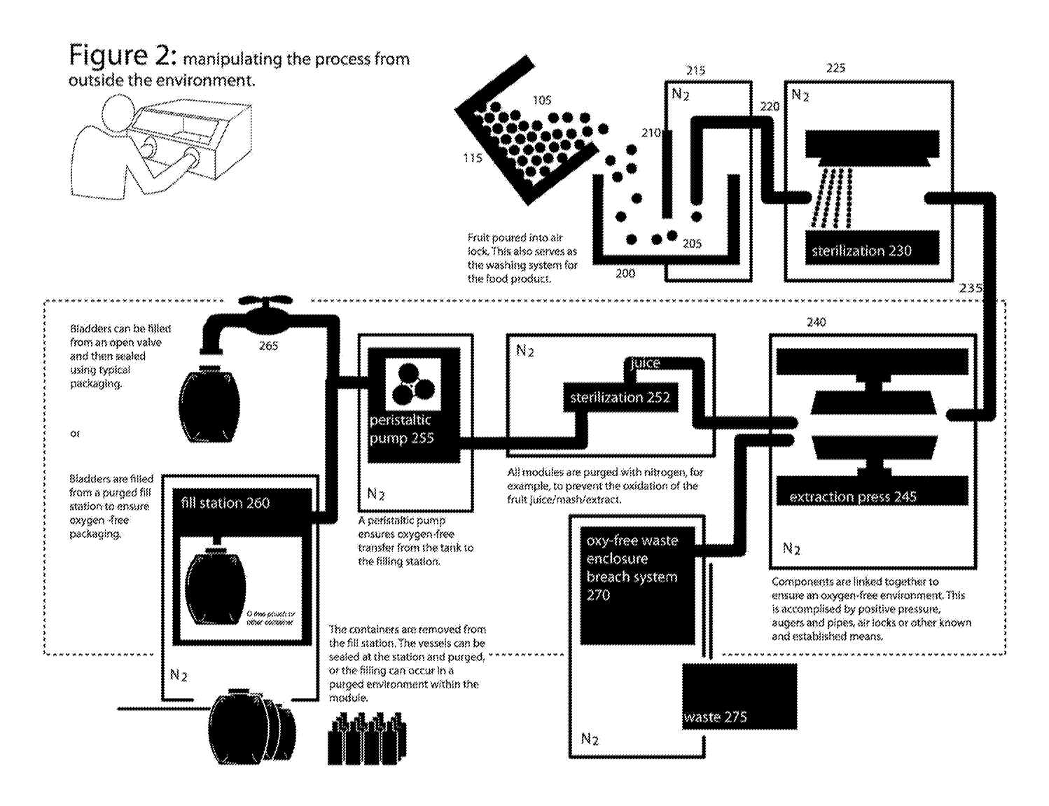

Referring next to FIG. 2, an alternative embodiment in accordance with the present invention is illustrated in schematic form. In general, the embodiment of FIG. 2 illustrates a system and method where the processing of food is managed from outside the oxygen-free, or purged, environment.

In particular, fruit 105 is loaded into container 115 in an open-air environment. The fruit is then deposited by any convenient means into a washing bin 200 filled with liquid 205. A baffle 210, which, for the embodiment shown here, forms a portion of a wall of oxygen-purged chamber 215, extends into the liquid 205 and separates the washing bin into open-air and oxygen-free portions. The fruit 105 passes from the open-air side, under the baffle 210, and then into the oxygen-free portion within chamber 215, and, now washed, is conveyed onward. The chamber 215 can be, like the remaining oxygen-free portions of FIG. 2, a glove box or similar enclosure, which allows workers to manipulate the fruit from outside the oxygen-free environment. As shown by the “N₂”, the chamber 215 and other similarly labeled chambers can be made oxygen-free by, for example, the use of nitrous oxide or other gas, typically sealed or under positive pressure. It will also be appreciated that, while the embodiment of FIG. 2 shows each station in a separate oxygen-free chamber, one or more stations can be enclosed in a single chamber, in an arrangement having some of the characteristics of the embodiment of FIG. 1, and some of the embodiment of FIG. 2. It will further be appreciated that, if multiple stations are combined within a single enclosure, the conveyancing of the fruit or juice between them can be open.

After washing, the fruit is conveyed via piping or similar enclosed means to a second oxygen-free chamber 225, where UV sterilization, seen at 230 of the fruit occurs as described in connection with FIG. 1. From there, the fruit is delivered, again by piping 235 or similar means, into a third oxygen-free chamber 240 (or via an open system if also enclosed) containing an extraction press 245 or other processes such as emulsifying, centrifuging, and the like, where the fruit is juiced or otherwise processed as discussed in connection with the embodiment of FIG. 1. It will be appreciated by those skilled in the art that, while oxygen-free chambers 215 and 225 can be provided, the key portions of the process where oxygen-free environments are the most important begins with chamber 240 and the extraction of the juice by press 245. As before, the extraction process can include filtration to remove any undesired pulp, as well as seeds, rind, etc. Alternatively, the extraction process can create a mash, extract, or other product. For purposes of the present example, it is assumed that the intention is to extract juice.

Following extraction, the juice and waste are separated, and the juice is passed through an inline pasteurization process 252, then piped to either oxygen-free tank or pumped in an oxygen-free manner, for example by peristaltic pump 255, to either a filling station 260 or an sealed valve 265, as discussed in connection with FIG. 1.

Also similar to FIG. 1, the waste from the extraction process is captured in waste enclosure 270, and exits the system at 275.

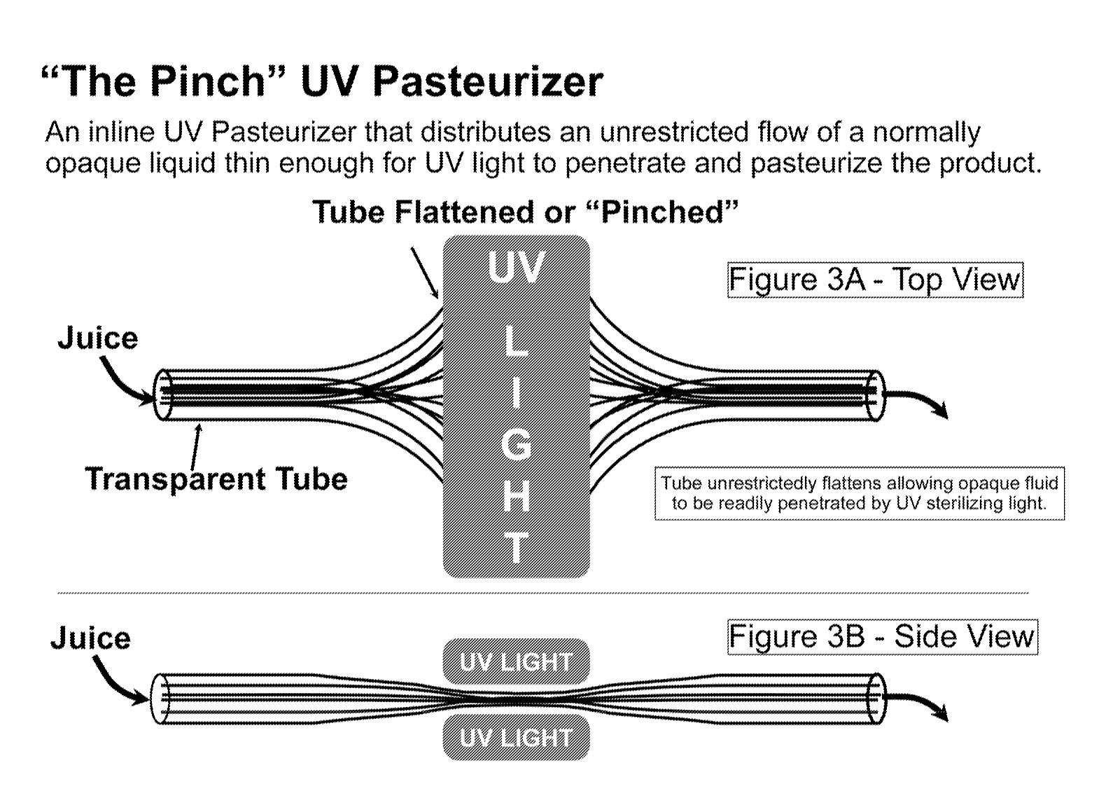

Referring next to FIGS. 3A and 3B, top and side views of an embodiment of a UV Pasteurizer suitable for use with the systems and methods of FIGS. 1 and 2 are shown. In particular, the “Pinch” pasteurizer shown in FIGS. 3A-3B thins, in at least one dimension, a stream of a normally opaque or semi-opaque fluid, such as fruit juice, to the point that the stream is thin enough to permit UV light to penetrate the entirety of the stream and thus pasteurize the stream. As shown in FIGS. 3A-3B, juice or other fluid being processed enters a a tube 300 that is transparent to UV, as shown at the left. The tube is then flattened sufficiently, shown at 305, that UV light from source 310 can penetrate the stream and pasteurize or deactivate pathogens in the juice. The tube can then be returned to its original shape and the juice continues to the next phase of processing, shown at 315. By adjusting the relative width and thinness of the portion 305, the flow of juice can continue unobstructed through the UV light, thus enabling continuous processing. The thinness of the portion 305 is, in at least some embodiments, adjusted in accordance with the output of UV source 310, to optimize fluid flow while still ensuring thorough pasteurization.

Having fully described a preferred embodiment of the invention and various alternatives, those skilled in the art will recognize, given the teachings herein, that numerous alternatives and equivalents exist which do not depart from the invention. It is therefore intended that the invention not be limited by the foregoing description, but only by the appended claims.

I claim:

1. A food processing system comprising
a sterilizer stage for substantially sterilizing the surface of food to be processed,
an extraction stage for extracting juice from the food to be processed after the surface is substantially sterilized,
an ultraviolet exposure stage for deactivating pathogens in the extracted juice,
a packaging stage for packaging the extracted juice following ultraviolet exposure,
wherein at least the sterilizer stage, the extraction stage, and the ultraviolet exposure stage are maintained in an one or more chambers filled with inert gas.

2. A pathogen deactivation device comprising
an ultraviolet light source,
an intake tube for receiving a stream of liquid,
an outlet tube for outputting the stream of liquid, and
an intermediate tube, transparent to ultraviolet light, interposed between the intake tube and the outlet tube, the intermediate tube being flattened such that the height of the intermediate tube is substantially less than the width of the tube and the entirety of the stream of liquid is sufficiently exposed to the ultraviolet light source that substantially all of the pathogens in the stream of liquid are deactivated.
